(19) United States
(12) Patent Application Publication
(10) Pub. No.: US 2026/0352673 A1
(43) Pub. Date: Nov. 5, 2026

(54) Rapid Blast Radius Computation Using N-Way Joins

(71) Applicant: Palo Alto Networks, Inc., Santa Clara, CA (US)

(72) Inventors: Chandra Biksheswaran MOULEESWARAN, Cupertino, CA (US); Ajaya NEUPANE, San Jose, CA (US); Alok TONGAONKAR, San Jose, CA (US); Rama Teja REPAKA, San Jose, CA (US); Xiaoyan WANG, Pleasanton, CA (US); Parul SHUKLA, Cupertino, CA (US)

(21) Appl. No.: 19/194,446

(22) Filed: Apr. 30, 2025

(51) Int. Cl. H04L 9/40; G06F 16/22; G06F 16/2453

(52) U.S. Cl. CPC H04L 63/1416; G06F 16/2228; G06F 16/24544

(57) ABSTRACT

A threat detection system is disclosed that determines reachability to a crown jewel asset in response to a cloud environment event involving a principal that triggers blast radius analysis. The system monitors events of a cloud environment for an event that triggers blast radius analysis. The system identifies a principal indicated in the trigger event, initializes a join set with the principal, and queries a search index of cloud entities for the principal. The system then explores paths from the principal via entities that qualify as neighbors according to blast radius analysis constraints with successive queries on entities in search results. Each valid neighbor is joined with the join set until a halting condition is reached. If a crown jewel asset is reached, then a blast radius graph has been constructed with the joins and a visualization of the blast radius graph can be presented in addition to an alert.

### BACKGROUND

The disclosure generally relates to cybersecurity in a cloud environment (e.g., CPC subclass H04L 63).

Malicious actors use tactics including lateral movement and privilege escalation to access critical assets of an organization. These critical assets are often referred to as crown jewels. A critical asset can be sensitive data or a critical system or system component. These tactics leverage a sequence of misconfigurations and/or vulnerabilities of a cloud environment. These sequences are referred to as attack paths. Blast radius graphs can be constructed to visually present or logically encode these attack paths to crown jewels.

Inner joins (hereinafter “joins”) are operations in relation algebra used to merge results across indexes in relational databases based on common values for a particular column or object. Results are joined based on having identical values for specific entries of each column value or object in the relational database as specified by a join query to the database. Joins can be combined across more than two indexes using an “and” logical operator by merging join results from each of the pairwise join operations.

### BRIEF DESCRIPTION OF THE DRAWINGS

Embodiments of the disclosure may be better understood by referencing the accompanying drawings.

FIG. 1 is a diagram of a system detecting reachability of any crown jewel asset based on blast radius analysis of a trigger environment detected from monitoring a cloud environment.

FIG. 2 is a diagram of an example n-way join that constructs a blast radius graph.

FIG. 3 is a flowchart of example operations for constructing a blast radius graph with an n-way join of valid paths from a trigger event principal(s).

FIG. 4 depicts an example computer system with an n-way join based blast radius analyzer.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

The description uses the term “principal” as used in a cloud computing context. A principal is any entity that can be authenticated and authorized to interact with cloud resources according to a granted permission. A principal can be a user, process/service, service account, or application.

A “crown jewel” of an organization refers to a critical asset of the organization. A critical asset can be sensitive data, a critical system, or critical system component. In general terms, a critical asset is an asset that will cause harm to an organization, including harm to value or harm to reputation of the organization, if the critical asset is exfiltrated, corrupted, or compromised. In a cloud computing context, a resource that hosts or contains a critical asset is also referred to as a critical asset.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

A threat detection system is disclosed that determines reachability to a crown jewel asset in near real-time in response to a cloud environment event involving a principal that triggers blast radius analysis. The threat detection system can be deployed in-line with respect to events and cloud assets. The threat detection system monitors events of a cloud environment for an event that triggers blast radius analysis. The threat detection system identifies a principal indicated in the trigger event. The threat detection system initializes a join set with the principal and queries a search index of cloud entities for the principal. The threat detection system then explores paths from the principal via entities that qualify as neighbors according to blast radius analysis constraints with successive queries on entities in search results. Each valid neighbor is joined with the join set until a halting condition is reached. If the halting condition does not include reaching a crown jewel asset, then the join set is discarded. If a crown jewel asset is reached, then a blast radius graph has been constructed with the joins and a visualization of the blast radius graph can be presented in addition to an alert.

### Example Illustrations

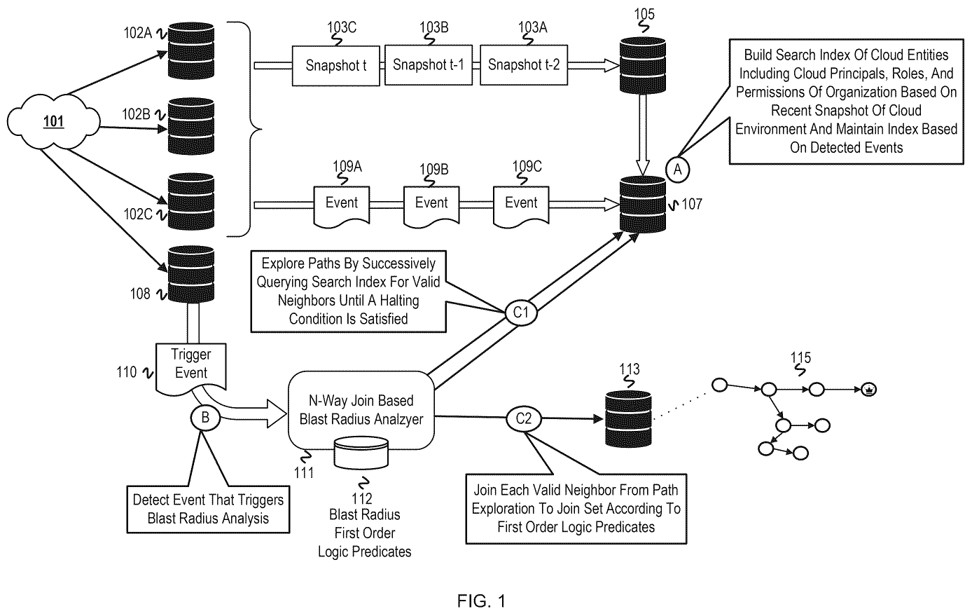

FIG. 1 is a diagram of a system detecting reachability of any crown jewel asset based on blast radius analysis of a trigger environment detected from monitoring a cloud environment. FIG. 1 depicts a cloud environment 101 of an organization and repositories 102A-102C, which are examples of state data being collected and stored for a cloud environment 101 across different repositories. The separation of collected data indicating state of a cloud environment can be due to various reasons, such as different monitoring tools. For instance, the repositories 102A-102C can correspond to Identity and Access Management (IAM) data, cloud security posture management (CSPM) data, and data security posture management (DSPM) data, respectively. FIG. 1 illustrates a single cloud environment 101 of an organization, but an organization can have multiple cloud environments across cloud service providers (CSPs) and in either or both of public and private clouds. FIG. 1 illustrates building and maintaining a search index 107 and cloud environment monitoring with a n-way based blast radius analyzer 111.

FIG. 1 is annotated with a series of letters A, B, C1, and C2 representing stages of operations, each stage corresponding to one or more operations. Stage A corresponds to the building and maintaining of the search index 107. Stages C, C2 correspond to the blast radius analysis. Although these stages are ordered for this example, the stages illustrate one example to aid in understanding this disclosure and should not be used to limit the claims. Subject matter falling within the scope of the claims can vary from what is illustrated.

At stage A, the system builds and maintains the search index 107. To initially build the search index, the system uses a recent snapshot of state of the cloud environment 101. Another system of the organization will periodically generate a snapshot of the cloud environment 101 based on data in the repositories 102A-102C. FIG. 1 illustrates a series of snapshots 103A-103C being taken and stored into a repository 105. The most recent snapshot 103C taken at a time t is used as a seed for building the search index 107. The search index 107 indexes the data by cloud entities. Entities of a cloud environment at least include principals, roles, permissions, and cloud resources or assets. Other examples of cloud entities include actions or commands, policies, and logical groupings, such as network groups and security groups. After the initial building of the search index 107, the system monitors the repositories 102A 102C for updates in order to apply corresponding updates to the search index 107. FIG. 1 depicts events 109A-109C flowing from the repositories 102A-102C to the search index 107 as an illustration of the ongoing maintenance of the search index 107. After building the search index 107, the system can begin monitoring the cloud environment 101 for trigger events while the system continues maintaining the search index 107.

At stage B, the system detects a trigger event 110 while monitoring the cloud environment 101. The system monitors a repository(ies) 108 of logs, such as cloud event, configuration, and/or audit logs. The system monitors for cloud events that satisfy a trigger criterion, which is an event that indicates a principal.

The operations represented by stages C1 and C2 overlap. At stage C1, the system explores paths from the principal indicated in the trigger event 110. Path exploration involves successively querying the search index 107. Initially, the system queries the search index 107 with the principal (i.e., principal identifier) as a search parameter. The system examines the search result to identify any valid neighbor, a valid neighbor being a cloud entity that satisfies criteria for validity that corresponds to sequences of cloud entities for reaching a crown jewel asset. For each cloud entity identified that qualifies as a valid neighbor, the queries the search index 107 for the valid neighbor. The system continues exploring a path until a halting condition is satisfied, either the valid neighbor is a crown jewel asset or a depth or distance limit has been reached. At stage C2, the system joins each valid neighbor to a join set. The join set initially consists of the principal identified in the trigger event 110. Each successive join operation yields a join set which can be considered an intermediate dataset that represents the state of the path exploration. Joins are according to first order logic predicates defined for blast radius analysis for crown jewel asset reachability. The first order logic predicates can vary depending on the trigger criterion that was satisfied to trigger the blast radius analysis. For instance, different first order logic predicates can be defined for principals are users and principals that are compute instances. If the path exploration reaches a crown jewel asset, the corresponding join set will include the cloud entities and relationships corresponding to a blast radius graph 115. The system can invoke a rendering engine or user interface engine to generate a visualization of the blast radius graph 115 after the system prunes paths that do not reach a crown jewel asset.

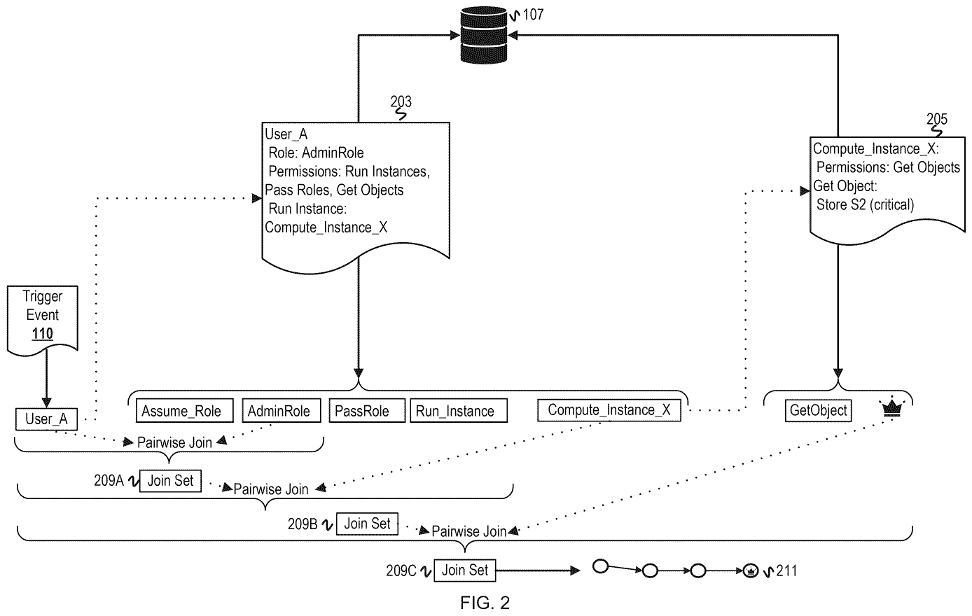

FIG. 2 is a diagram of an example n-way join that constructs a blast radius graph. It is presumed for FIG. 2 that the principal identified in the trigger event 110 is a principal “User_A” and that the trigger event is that the User_A temporarily assumed an administrator role. Querying the search index 107 for User_A yields a search result 203. The search result 203 is an object for the administrator role that specifies the administrator role assumed by UserA, the permissions granted to User_A by assuming the administrator role, and a Compute_Instance_X that the User_A has launched based having the Run Instances permission. The permissions also include passing roles and accessing objects with the “Get Object” action. The administrator role “Admin Role” is a cloud entity that qualifies as a valid neighbor to User_A. Thus, AdminRole is pairwise joined with User_A with a relationship Assume_Role, which yields a join set 209A. In addition, the Compute_Instance_X is identified as a valid neighbor to AdminRole. Thus, Compute_Instance_X is pairwise joined with the join set 209A with a relationship that is a combination of “PassRole” and “Run_Instance” permissions to yield a join set 209B. The search index 107 is then queried for Compute_Instance_X which yields a search result 205 that specifies a permission for the compute instance to access objects with the “Get Object” action allowed by the AdminRole permissions that were passed to Compute_Instance_X. The search result 205 also identifies a cloud resource S2 that can be accessed with the Get Object action and indicates that S2 is a critical asset. The critical asset is pairwise joined with the join set 209B with the relationship GetObject to yield a join set 209C. A 4-way join has created the join set 209C which indicates a blast radius graph 211.

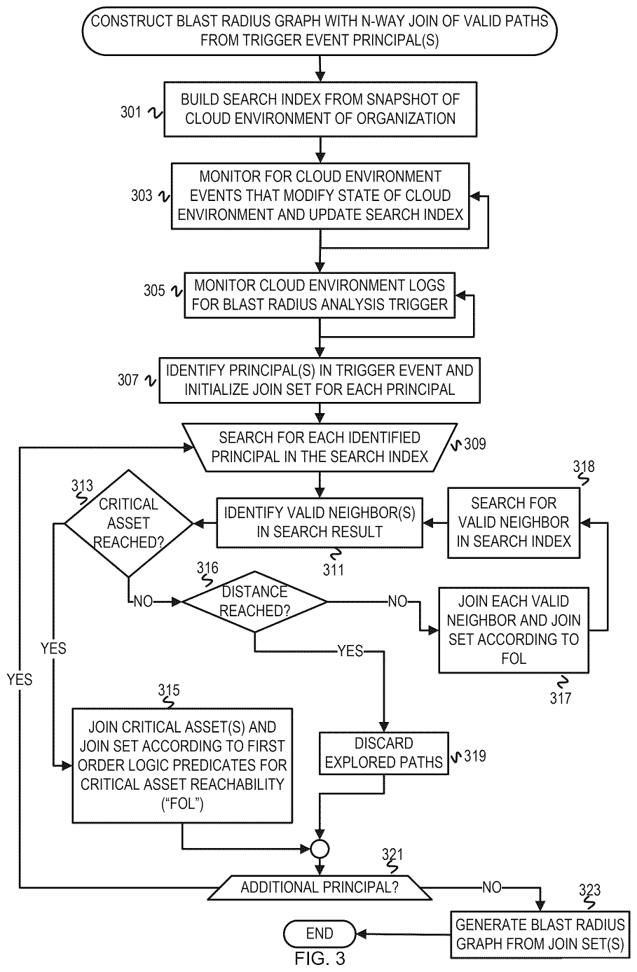

The examples illustrated in FIGS. 1 and 2 use the case of a single principal being identified in a trigger event. However, a trigger event can indicate multiple principals which can then lead to exploration of multiple paths from each indicated principal. FIG. 3 presents example operations that go beyond the single principal case. The example operations are described with reference to a n-way join based blast radius analyzer for consistency with FIG. 1 and ease of understanding. The name chosen for program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for constructing a blast radius graph with an n-way join of valid paths from a trigger event principal(s). The example operations of FIG. 3 encompass the creation and maintenance of a search index for efficient querying and runtime or in-line monitoring of cloud events using the search index for blast radius analysis that can occur in sufficient time (e.g., a few minutes) to prevent an attack instead of reacting to access of a critical asset or never detecting the access.

At block 301, the n-way based blast radius analyzer builds a search index from a snapshot of cloud environment of an organization. A snapshot of each cloud environment (e.g., snapshot of a file system or volume(s) of each cloud environment) of the organization is used to build the search index, such as an inverted search index. The search index is built to index each cloud entity or cloud resource that can be a node or an edge in a blast radius graph.

At block 303, the n-way based blast radius analyzer monitors for cloud environment events that modify the state of the cloud environment(s) as represented by the snapshot(s). The data sources of the snapshot(s) can be monitored for updates according to a change data capture (CDC) paradigm, streaming data pipelines, extract transform load (ETL) data pipelines, etc. The search index is then updated based on detected updates to the data sources to maintain a current search index. This is ongoing as represented by the arrow returning to block 305. Operational flow also continues to block 305.

At block 305, the n-way based blast radius analyzer monitors cloud environment logs for a blast radius analysis trigger. For instance, the n-way based blast radius analyzer can monitor logs of a cloud environment for events or updates according to a publisher-subscriber paradigm. The n-way based blast radius analyzer can subscribe to updates to the logs that satisfy blast radius trigger criteria (e.g., a changelog event or cloud event that indicates a principal performing one of a specified set of actions). Alternatively, the n-way based blast radius analyzer can subscribe to all events recorded into the logs and evaluate each event to determine whether it satisfies blast radius analysis trigger criteria.

At block 307, the n-way based blast radius analyzer identifies each principal indicated by a trigger event. For instance, a trigger event may indicate that a user instantiated a compute instance and passed the compute instance a role. In that case, the trigger event indicates two principals: the user and the compute instance. The n-way based blast radius analyzer initializes a join set for each principal indicated in the trigger event.

At block 309, the n-way based blast radius analyzer begins exploring paths from the principals identified from the trigger event (“triggering principals”). This path exploration is by successively querying the search index for each principal and for each principal successively querying the search index for cloud entities that are valid neighbors forming the paths.

At block 311, the n-way based blast radius analyzer identifies valid neighbors in search result. The n-way based blast radius analyzer examines the search result for indication of a cloud entity, such as a principal or role. The n-way based blast radius analyzer filters identified cloud entities by applying constraints specified in criteria for a cloud entity to be a valid neighbor. As examples, a cloud resource that is a principal, role, or storage resource can be a valid neighbor. Types of resources, such as a licensing server, may be disqualified as a valid neighbor. In addition, the valid neighbor criteria can specify other operations for a specified type of cloud resource. For instance, a cloud resource indicated in a search result that is a load balancer may trigger aggregation of currently explored paths from the current triggering principal by joins. If multiple valid neighbors are identified, the n-way based blast radius analyzer can create a set of valid neighbors of the current iteration/distance for tracking queries to the search index for valid neighbors at the current distance.

At block 313, the n-way based blast radius analyzer determines whether a critical asset has been reached. The n-way based blast radius analyzer examines the search result to determine whether any valid neighbor is a critical asset since reaching a critical asset is a halting condition for path exploration. If a critical asset has been reached, then operational flow proceeds to block 315. In addition, an alert can be generated that indicates the reachability of the critical asset and the trigger event while path exploration continues. If a critical asset has not been reached (i.e., none of the valid neighbors is a critical asset), then operational flow proceeds to block 316.

At block 315, the n-way based blast radius analyzer joins each critical asset with the join set according to first order predicates corresponding to critical asset reachability. If multiple valid neighbors at the current distance are critical assets, then each critical asset is joined with the current distance join set. If r critical assets were identified at the current distance, then r join sets will result corresponding to the path branching to the r critical assets. Below is an example of a first order logic predicate for a join in the context of a user principal and a compute instance principal which indicates a compute instance as C5 and a storage cloud resource as S2.
context where resource=IAMUser and constraint_rule=IAMUser has admin role as X;
context where resource=C5 and constraint rule=launchedBy(IAMUser) as Y;
filter=$.X.AdminRole can iam:PassRole on AdminRole
and
$.X.AdminRole can C5:RunInstances
and
$.Y.C5 inherits AdminRole
and
$.X.AdminRole can S2:GetObject on SensitiveStore
and
$.X.AdminRole can C5_Connect:SendSSHPublicKey on OtherC5;
Show Y;
   The sequences of example constraints are derived from cybersecurity knowledge of various attack scenarios relevant to the blast radius analysis domain. The constraints rely on the first order logic use of variables X for any IAMUser that has admin role and Y for any compute instance that has been launched by an IAMUser. Each of element of this sequence of constraints or join set corresponds to a link or fragment of a path that may become a part of a path to a critical asset. Operational flow proceeds to block 321.

At block 316, the n-way based blast radius analyzer determines whether a defined distance has been reached. To limit path exploration, a distance d is defined as a halting condition. The basis for d can be observations of likelihood of critical asset reachability falling below a probability deemed a safe threshold for unlikely critical asset reachability. If the current distance is d and no critical assets have been identified in the set of valid neighbors, then paths currently being explored from the triggering principal are discarded at block 319. Discarding of explored paths includes discarding the identified neighbors and the join sets that have been created for the paths that have reached the distance d without reaching a critical asset. Operational flow proceeds from block 319 to block 321. If d has not been reached, then operational flow proceeds to block 317 from block 316.

At block 317, the n-way based blast radius analyzer joins each valid neighbor with the join set corresponding to the path explored so far to the current distance and the join is according to first order predicates for critical asset reachability. If multiple valid neighbors at the current distance have been identified, then each valid neighbor is joined with the current distance join set. If n valid neighbors were identified at the current distance, then n join sets will result corresponding to the path branching to the n valid neighbors.

At block 318, the n-way based blast radius analyzer searches for valid neighbor in the search index. If the path has branched to multiple valid neighbors, then multiple queries will be submitted to the search index for the multiple valid neighbors.

Operational flow continues to block 311 from block 318 for examination of the search result(s).

At block 321, the n-way based blast radius analyzer determines whether there is another triggering principal to analyze for blast radius path exploration. If so, operational flow returns to block 309. Otherwise, operational flow proceeds to block 323.

At block 323, the n-way based blast radius analyzer generates a blast radius graph from the one or more join sets created. If multiple join sets were created for a triggering principal because the paths branched and reached multiple critical assets, then the join sets are merged for the triggering principal. Merging join sets can involve concatenating a terminal node of a path of a previous exploration step to a starting node of a next step. The concatenating is subject to constraints based on types of relationships and entities or resources being related. If paths were explored from multiple triggering principals and reached critical assets, then the corresponding join sets are also merged to construct the blast radius graph. The merged join sets can be passed or indicated to a rendering engine or graphical graph builder to generate a visualization of the blast radius graph.

### Variations

The example illustrations are provided to aid in understanding the disclosure but should not be used to limit embodiments. For instance, n-way join based blast radius analysis is not limited to forward path exploration or forward propagation from a triggering principal. As an example, path exploration for critical asset reachability from critical assets (“backward propagation”). Moreover, n-way join based blast radius analysis can conduct path exploration forwards from principals and backwards from critical assets (“bi-directional search). Bi-directional search can discover paths in less time that either the forward or backward propagation alone. As another example of variations, embodiments can use multi-processing or multi-threading for blast radius analysis of multiple events that occur within a time interval that is less than the time for blast radius analysis. Results of each thread/process that have reached a halting condition can be combined to form a blast radius graph. As another example of variations, implementations may be limited by the search index technology to accessing partial search results (e.g., 10,000 results per page or chunk of search results). In that case, embodiments can paginate join sets of partial search results and then merge the join set of the next set of search results to the paginated join set(s). Furthermore, embodiments are not limited to blast radius analysis for reachability of critical cloud assets. N-way join based path computation can be applied in other contexts for computing paths between an identified/given node and a target node according to defined constraints.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, path exploration is not necessarily serial across triggering principals as described in FIG. 3. Embodiments can explore paths from each triggering principal in parallel. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

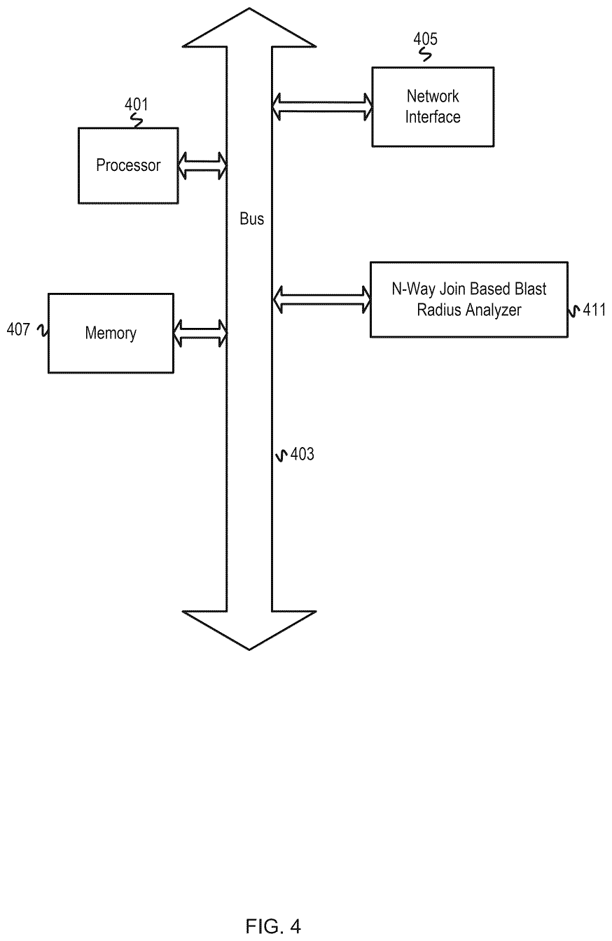

FIG. 4 depicts an example computer system with an n-way join based blast radius analyzer. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The system also includes a n-way join based blast radius analyzer 411. The n-way join based blast radius analyzer 411 uses a search index of cloud entities for one or more cloud environments of an organization to rapidly explore paths from a principal in a triggering cloud event for critical asset reachability. The n-way join based blast radius analyzer 411 incrementally explores paths from a triggering principal by determining cloud resources related by specified set of actions or permissions (e.g., actions or permissions that allow roles to be inherited, launching of other principals, or accessing cloud resources). The n-way join based blast radius analyzer 411 evaluates these related cloud entities against valid neighbor constraints to identify valid neighbors. The n-way join based blast radius analyzer 411 then retrieves from the search index information about the valid neighbors to identify any of their valid neighbors (or next depth/distance valid neighbors. For each distance/depth of valid neighbors, the n-way join based blast radius analyzer 411 uses join operations to incrementally construct a (potential) blast radius graph. The n-way join based blast radius analyzer 411 joins each valid neighbor with a join set of the corresponding path being explored/constructed. The n-way join based blast radius analyzer 411 continues until either reaching a critical asset or target node, or reaching a defined depth/distance limit for analysis. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

1. A method comprising:
generating a search index of cloud entities based on a recent snapshot of a cloud environment;
updating the search index based on events in the cloud environment detected subsequent to the snapshot;
based on detection of a trigger event while monitoring the cloud environment, near real-time determining blast radius of the trigger event with respect to crown jewel assets, wherein the near real-time determining of blast radius of the trigger event comprises,
identifying each principal indicated in the trigger event;
for each principal,
querying the search index for the cloud entity and successively querying the search index for each valid neighbor entity identified in search results until satisfying a halting condition; and
for each search result from the search index, determining each cloud entity indicated in the result that is a valid neighbor based on being related by one of a set of specified relationships, joining each valid neighbor to a join set that initially includes the principal, and determining whether the halting condition has been satisfied, wherein the joining is according to a plurality of first order logic predicates corresponding to reachability of crown jewel assets; and
merging the results of joining to build a blast radius graph.

2. The method of claim 1 further comprising merging subsets of results of the joins based on a pagination limit, paginating the merged results, and successively merging the subsets into the paginated merged results.

3. The method of claim 1 further comprising, while monitoring the cloud environment, determining whether a detected event is a triggered event based on whether the detected event indicates a cloud entity that is a principal.

4. The method of claim 1, wherein a principal is a cloud resource that can take an action, be authenticated, have a role, or have a permission and a relationship is a permission, role, or vulnerability.

5. The method of claim 1, wherein the plurality of first order logic predicates indicates cloud entities and relationships among cloud entities that correspond to reachability of crown jewel assets and indicates sequences of entities and relationships among entities in the sequences that correspond to reachability of crown jewel assets.

6. The method of claim 1, wherein successively querying the search index for each valid neighbor entity identified in search results until satisfying a halting condition comprises successively querying the search index for each valid neighbor entity identified in search results until identifying a neighbor entity that is a critical or sensitive asset or reaching a neighbor entity at a defined distance limit.

7. The method of claim 1, wherein the search index is an inverted search index.

8. The method of claim 1 further comprising, prior to merging results, discarding a join set of a principal that does not satisfy a halting condition of reaching a crown jewel asset.

9. A non-transitory, machine-readable medium having stored therein program code comprising instructions to:
based on detection of an event that satisfies a criterion to trigger blast radius analysis while monitoring one or more logs of a cloud environment, incrementally compute a set of one or more paths from each principal of the event and construct a blast radius graph from at least some of the set of one or more paths, wherein the instructions incrementally compute a set of one or more paths from each principal of the event and construct a blast radius graph comprise instructions to,
identify each principal of the event;
for each principal,
query a search index for the principal and examine search results to identify each cloud entity that qualifies as a neighbor according to neighbor constraints that specify cloud entity types that can be a neighbor and actions or permissions that can relate a neighbor, wherein the search index indicates cloud entities of the cloud environment;
join each neighbor with the principal according to a corresponding one of a plurality of first order logic predicates to incrementally construct a path; and
successively query the search index for each neighbor and successive neighbor until satisfying a halting condition and join each successive neighbor to results of a preceding join according to the plurality of first order logic predicates; and
merge results of the joins to build a blast radius graph.

10. The non-transitory, machine-readable medium of claim 9, wherein the program code further comprises instructions to merge subsets of results of the joins based on a pagination limit for search results, paginate the merged results, and successively merge the subsets into the paginated merged results.

11. The non-transitory, machine-readable medium of claim 9, wherein the plurality of first order logic predicates indicates cloud entities and relationships among cloud entities that correspond to reachability of critical cloud assets and indicates sequences of entities and relationships among entities in the sequences that correspond to reachability of critical cloud assets.

12. The non-transitory, machine-readable medium of claim 9, wherein the halting condition is either reaching a defined depth limit or reaching a critical asset.

13. The non-transitory, machine-readable medium of claim 12, wherein the program code further comprises instructions to, prior to merging results, discard a join set of a principal that reaches the defined depth limit without reaching a critical cloud asset.

14. The non-transitory, machine-readable medium of claim 9, wherein the program code further comprises instructions to build the search index from a snapshot of the cloud environment and to update the search index based on updates to one or more data sources that informed the snapshot.

15. An apparatus comprising:
a processing; and
a machine-readable medium having stored thereon instructions executable by the processor to cause the apparatus to,
based on detection of an event that satisfies a criterion to trigger blast radius analysis while monitoring one or more logs of a cloud environment, incrementally compute a set of one or more paths from each principal of the event and construct a blast radius graph from at least some of the set of one or more paths, wherein the instructions incrementally compute a set of one or more paths from each principal of the event and construct a blast radius graph comprise instructions to,
identify each principal of the event;
for each principal,
query the search index for the principal and examine search results to identify each cloud entity that qualifies as a neighbor according to neighbor constraints that specify cloud entity types that can be a neighbor and actions or permissions that can relate a neighbor;
join each neighbor with the principal according to a corresponding one of a plurality of first order logic predicates to incrementally construct a path; and
successively query the search index for each neighbor and successive neighbor until satisfying a halting condition and join each successive neighbor to results of a preceding join according to the plurality of first order logic predicates; and
merge results of the joins to build a blast radius graph.

16. The apparatus of claim 15, wherein the machine-readable medium further has stored thereon instructions executable by the processor to cause the apparatus to merge subsets of results of the joins based on a pagination limit for search results, paginate the merged results, and successively merge the subsets into the paginated merged results.

17. The apparatus of claim 15, wherein the plurality of first order logic predicates indicates cloud entities and relationships among cloud entities that correspond to reachability of critical cloud assets and indicates sequences of entities and relationships among entities in the sequences that correspond to reachability of critical cloud assets.

18. The apparatus of claim 15, wherein the halting condition is either reaching a defined depth limit or reaching a critical asset.

19. The apparatus of claim 18, wherein the machine-readable medium further has stored thereon instructions executable by the processor to cause the apparatus to, prior to merging results, discard a join set of a principal that reaches the defined depth limit without reaching a critical cloud asset.

20. The apparatus of claim 15, wherein the machine-readable medium further has stored thereon instructions executable by the processor to cause the apparatus to build the search index from a snapshot of the cloud environment and to update the search index based on updates to one or more data sources that informed the snapshot.
